(19) United States
(12) Patent Application Publication
(10) Pub. No.: US 2009/0103743 A1
(43) Pub. Date: Apr. 23, 2009

(54) ECHO CANCELLER

(75) Inventor: Yuuji HONDA, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/207,553

(22) Filed: Sep. 10, 2008

(30) Foreign Application Priority Data
Oct. 23, 2007 (JP) 2007-275026

(51) Int. Cl. H04B 3/20

(52) U.S. Cl. 381/66

(57) ABSTRACT

An echo canceller includes a residual signal generation unit, a double talk detection unit, a nonlinear processor, a speech detection unit, and an input/output characteristic change unit. The residual signal generation unit generates a pseudo echo signal, and generates a residual signal by using the pseudo echo signal. The double talk detection unit detects the state of the transmission signal. The nonlinear processor attenuates the residual signal that has been inputted thereto to a signal level which is based on a predetermined input/output characteristic, and that outputs the attenuated residual signal. The speech detection unit detects whether or not speech is included in the reception signal. The input/output characteristic change unit changes the input/output characteristic of the nonlinear processor to a predetermined input/output characteristic when a single talk state has been detected at the double talk detection unit and speech has been detected at the speech detection unit.

### CROSS-REFERENCE TO RELATED APPLICATION

This application claims priority under 35 USC 119 from Japanese Patent Application No. 2007-275026, the disclosure of which is incorporated by reference herein.

### BACKGROUND OF THE INVENTION

1. Field of the Invention

The present invention relates to an echo canceller and particularly to an echo canceller that can prevent breaks in a transmission signal even when a far end talker continues talking.

2. Description of the Related Art

Usually, an echo canceller is widely used in order to cancel telephone line echo that occurs in 2-line and 4-line components of telephone lines and acoustic echo that occurs in speaker and microphone components as in hands-free systems. FIG. 5 is a configural diagram showing an example of a typical echo canceller. The typical echo canceller shown in FIG. 5 is configured to include analog-digital (A/D) converters, digital-analog (D/A) converters, an adaptive FIR filter (AFF), adders, a double talk detector (DTD) and a nonlinear processor (NLP).

An analog reception signal Rin that has been inputted from a far end side 101 is converted to a digital reception signal Rin(k) by an A/D converter, becomes a digital signal Rout(k), is again converted to an analog signal Rout by a D/A converter, and is transmitted to a near end side through a telephone line or a speaker.

Meanwhile, when an analog transmission signal Sin, which includes an echo 102 that has occurred in 2-line and 4-line components of telephone lines and speaker and microphone components and a signal that is transmitted from a near end side 103, is inputted from the near end side, the analog transmission signal Sin is converted to a digital transmission signal Sin(k) by an A/D converter.

In the echo canceller body, there is generated a digital residual signal Res(k) from which the echo component has been cancelled as a result of the AFF estimating the characteristic of the echo path and generating a pseudo echo signal Sinh(k), and the pseudo echo signal Sinh(k) being subtracted from the analog transmission signal Sin(k) by an adder. Sometimes estimation of the echo path becomes distorted when the reception signal Rin is silent or when there is double talk where speech on the far end and speech on the near end exist at the same time. In order to avoid this problem, the DTD outputs an estimation inhibiting signal INH(k) with respect to the AFF when it is a double talk state and causes the AFF to stop estimation of the echo path.

Ordinarily, echo cannot be sufficiently cancelled by just the echo canceller body, so an NLP unit is disposed in order to suppress residual echo. The NLP shows a linear input/output characteristic as in FIG. 6A such that speech on the near end does not become broken when double talk has been detected because of the estimation inhibiting signal INH(k) from the DTD, but the NLP shows a nonlinear characteristic as in FIG. 6B when single talk has been detected, and if the absolute value of the residual signal Res(k) is equal to or less than a predetermined clip level CL, the NLP performs center clipping that forcibly outputs zero to suppress residual echo.

Because the NLP forcibly outputs zero when the input signal is equal to or less than the clip level in this manner, sometimes a feeling of strangeness is imparted when there are breaks in the transmission signal and during center clipping. Thus, technologies that reduce the feeling of strangeness, such as when there are breaks in the transmission signal, by variably setting the clip level are known (e.g., Japanese Patent No. 2,608,074 and Japanese Patent Application Laid-open (JP-A) No. 10-285083).

However, in conventional technologies such as described above, as the rate (hereinafter, referred to as a “ratio of echo to near end speech”) of the echo 102 in the transmission signal Sin that includes the echo 102 and the near end speech 103 becomes larger, there are instances where the DTD ends up determining the telephone call state to be single talk despite it being double talk, and there has been the problem that there are instances where this ends up leading to breaks in the transmission signal because the NLP shows a single talk input/output characteristic (FIG. 6B). In order to improve such breaks in the transmission signal, it suffices to set to the clip level to a low level, but in a hands-free system where the characteristic of the echo path easily changes, the clip level cannot be set to a low level regardless of whether it is fixed or variable in order to sufficiently suppress residual echo, so a satisfiable characteristic has not been obtained.

Particularly, for example, when the far end talker continues talking (e.g., continues saying “ahh”), the ratio of echo to near end speech becomes large and it becomes easier for the NLP to determine that the telephone call state is a single talk state, so breaks in the transmission signal become remarkable.

### SUMMARY OF THE INVENTION

The present invention has been made in view of the above circumstances and provides an echo canceller that can prevent breaks in a transmission signal even when a far end talker continues talking.

An aspect of the present invention provides an echo canceller including a residual signal generation unit, a residual signal generation unit, a nonlinear processor, a speech detection unit, and an input/output characteristic change unit.

The residual signal generation unit generates a pseudo echo signal, and generates a residual signal by subtracting the pseudo echo signal from a transmission signal that includes a residual echo generated by a reception signal. The double talk detection unit detects whether the state of the transmission signal is a double talk state or a single talk state. The nonlinear processor attenuates the residual signal that has been inputted thereto to a signal level which is based on an input/output characteristic that has been predetermined according to the state of the transmission signal, and that outputs the attenuated residual signal. The speech detection unit detects whether or not speech is included in the reception signal. The input/output characteristic change unit that changes the input/output characteristic of the nonlinear processor to a predetermined input/output characteristic when a single talk state has been detected at the double talk detection unit and speech has been detected at the speech detection unit.

### BRIEF DESCRIPTION OF THE DRAWINGS

FIG. 1 is a configural diagram showing an example of the general configuration of an echo canceller pertaining to a first embodiment of the present invention;

FIG. 2A to 2C are explanatory diagrams for describing single talk input/output characteristics of an NLP pertaining to the first embodiment of the present invention, with FIG. 2A showing a case where the input/output characteristic is not completely clipped, FIG. 2B showing a case where a clip level is smaller than normal and FIG. 2C showing a normal case;

FIG. 3 is a configural diagram showing an example of the general configuration of an echo canceller pertaining to a second embodiment of the present invention;

FIG. 4 is a configural diagram showing an example of the general configuration of an echo canceller pertaining to a third embodiment of the present invention;

FIG. 5 is a configural diagram showing an example of the general configuration of a conventional echo canceller; and

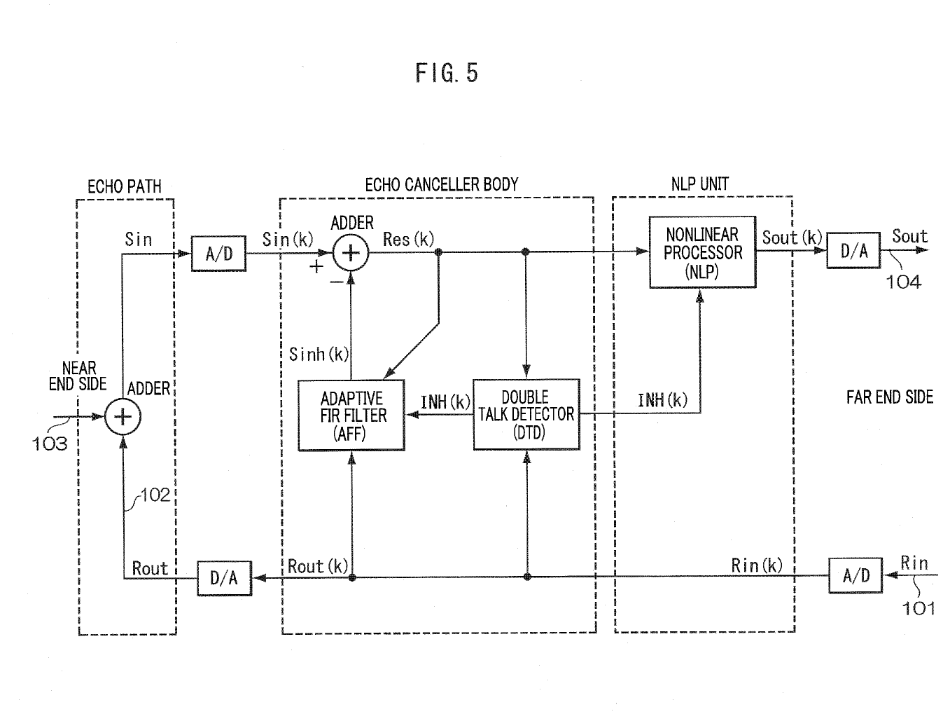

FIG. 6A and FIG. 6B are explanatory diagrams for describing input/output characteristics of an NLP in the conventional echo canceller, with FIG. 6A showing a case of double talk and FIG. 6B showing a case of single talk.

### DETAILED DESCRIPTION OF THE INVENTION

### First Embodiment

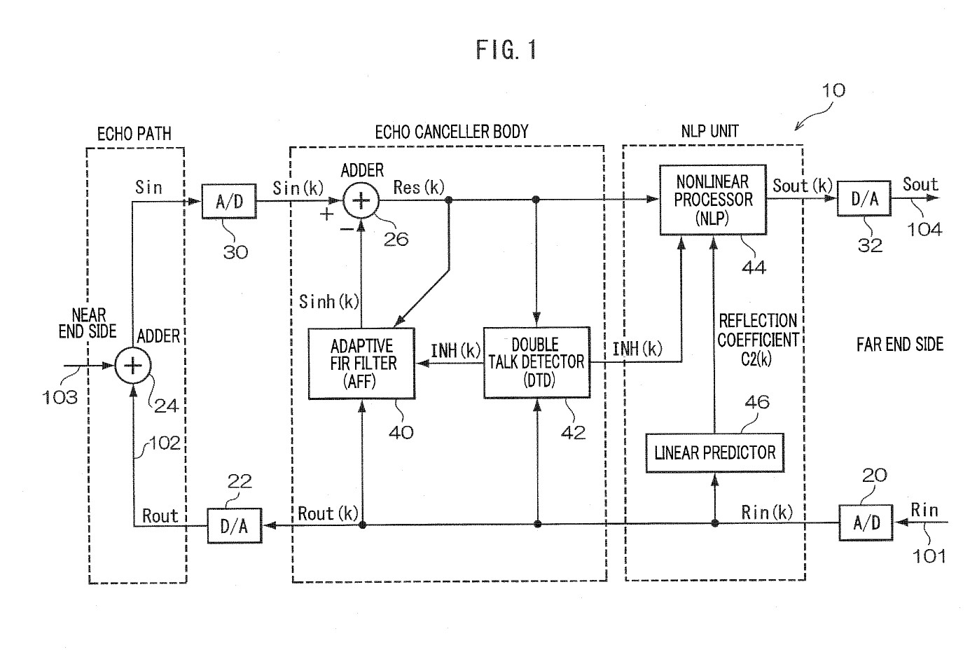

Below, a first embodiment of the present invention will be described in detail with reference to the drawings. FIG. 1 is a configural diagram showing an example of the general configuration of an echo canceller 10 pertaining to the first embodiment. It will be noted that, in the present embodiment, a case will be described where the echo canceller 10 is disposed with a linear predictor as a speech detection unit.

As shown in FIG. 1, the echo canceller 10 pertaining to the present embodiment is configured to include analog-digital (A/D) converters 20 and 30, digital-analog (D/A) converters 22 and 32, adders 24 and 26, an adaptive FIR filter (AFF) 40, a double talk detector (DTD) 42, a nonlinear processor (NLP) 44 and a linear predictor 46.

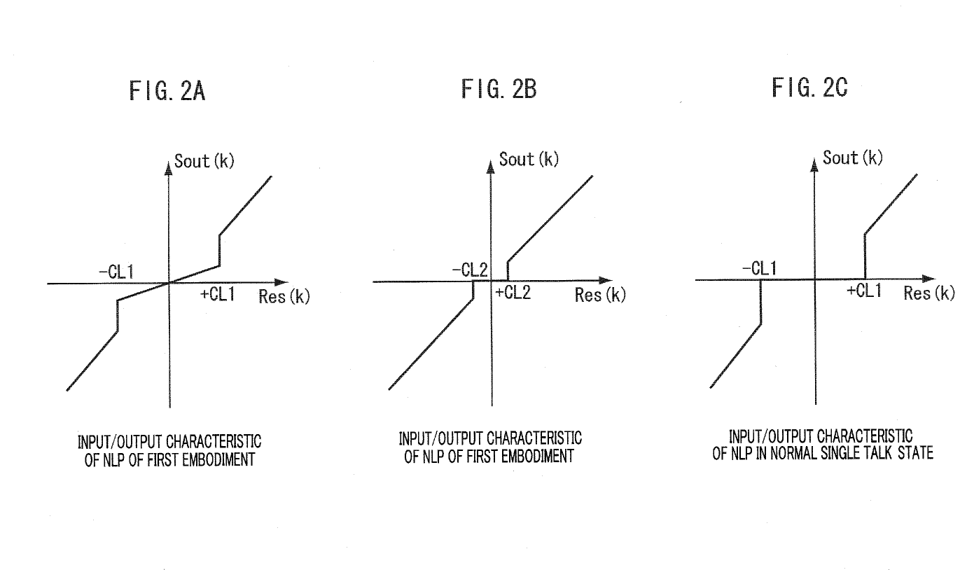

Operation of the echo canceller 10 of the present embodiment will be described in detail with reference to FIG. 1 and FIG. 2A to FIG. 2C.

When an analog reception signal Rin is inputted from a far end side 101, the analog reception signal Rin is sampled at each sampling time and converted to a digital reception signal Rin(k) by the A/D converter 20. The digital reception signal Rin(k) is applied to the AFF 40 and the DTD 42, becomes a digital reception signal Rout(k), is converted to an analog reception signal Rout by the D/A converter 22, and is transmitted to a near end side through a telephone line or a speaker.

Meanwhile, when an echo 102 that has occurred in an echo path such as 2-line and 4-line components of telephone lines or speaker and microphone components and a signal 103 such as speech that is transmitted from the near end side are added by the adder 24 and an analog transmission signal Sin that includes the echo 102 is inputted from the near end side, the analog transmission signal Sin is sampled at each sampling time and converted to a digital transmission signal Sin(k) by the A/D converter 30.

The AFF 40 of the echo canceller body estimates the characteristic of the echo path and generates a pseudo echo signal Sinh(k) by the estimated characteristic and convolution operation of the digital reception signal Rin(k), and a digital residual signal Res(k) from which the echo component has been cancelled as a result of the pseudo echo signal Sinh(k) being subtracted from (−Sinh(k) being added to) the digital transmission signal Sin(k) by the adder 30 is generated. The digital residual signal Res(k) is fed back to the AFF 40, and the AFF 40 performs estimation of the echo path such that the residual signal Res(k) becomes a minimum. It will be noted that, as the echo path estimation algorithm, a Least Mean Square (LMS) algorithm, a Normalized Least Mean Square (NLMS) algorithm and a Recursive Least Square (RLS) algorithm are widely known, but the echo path estimation algorithm is not limited to these algorithms. It will be noted that, in the present embodiment, the AFF 40 and the adder 26 correspond to a residual signal generation unit.

The DTD 42 compares the signal levels of the residual signal Res(k) and the reception signal Rin(k), outputs an estimation inhibiting signal INH(k) with respect to the AFF 40 when it is a double talk state, and causes the AFF 40 to stop estimation of the echo path. In this case, the AFF 40 performs just generation of the pseudo echo signal Sinh(k).

Next, operation of the NLP unit (operation of the NLP 44 and the linear predictor 46) will be described in detail.

First, detection by the linear predictor 46 in regard to whether or not speech is included in the digital reception signal Rin(k) will be described. The linear predictor 46 performs linear prediction analysis (LPC analysis) with respect to the digital reception signal Rin(k) using autocorrelation or the like. In the present embodiment, the linear predictor 46 calculates a 2-dimensional reflection coefficient C2(k). It will be noted that, in regard to the way in which the linear predictor 46 calculates the 2-dimensional reflection coefficient C2(k), it suffices for the linear predictor 46 to use a calculation method in typical linear prediction analysis. The 2-dimensional reflection coefficient C2(k) represents not a spectrum general form but the degree of sparseness and denseness of a spectrum with respect to a full band, and well represents the magnitude of the correlation of a signal waveform. In things having a resonator in their production mechanism, such as speech, there is a correlation in the signal waveform, so by comparing the 2-dimensional reflection coefficient C2(k) with a threshold value that has been predetermined, the linear predictor 46 can distinguish whether the signal with respect to which the linear predictor 46 has performed LPC analysis is speech or noise. That is, when the 2-dimensional reflection coefficient is equal to or greater than the threshold value, there is a correlation in the signal waveform, and the linear predictor 46 can distinguish that signal as speech.

So, the linear predictor 46 outputs the 2-dimensional reflection coefficient (shift average) C2(k) that it has calculated to the NLP 44.

Next, the NLP 44 judges whether speech is included in the digital reception signal Rin(k), that is, whether a far end talker is continuing to talk, when the 2-dimensional reflection coefficient C2(k) exceeds a threshold value THc2 for an amount of time equal to or greater than a set amount of time (e.g., equal to or greater than 1 second). It will be noted that, in the present embodiment, the reflection coefficient C2(k) is inputted to the NLP 44 and the NLP 44 judges whether or not speech is included (speech detection), but the embodiment is not limited to this and may also be one where just the speech detection result (whether or not the 2-dimensional reflection coefficient C2(k) is exceeding the threshold value THc2) is inputted to the NLP 44. Further, in the present embodiment, a case where the 2-dimensional reflection coefficient C2(k) has exceeded the threshold THc2 corresponds to satisfying a condition that has been predetermined.

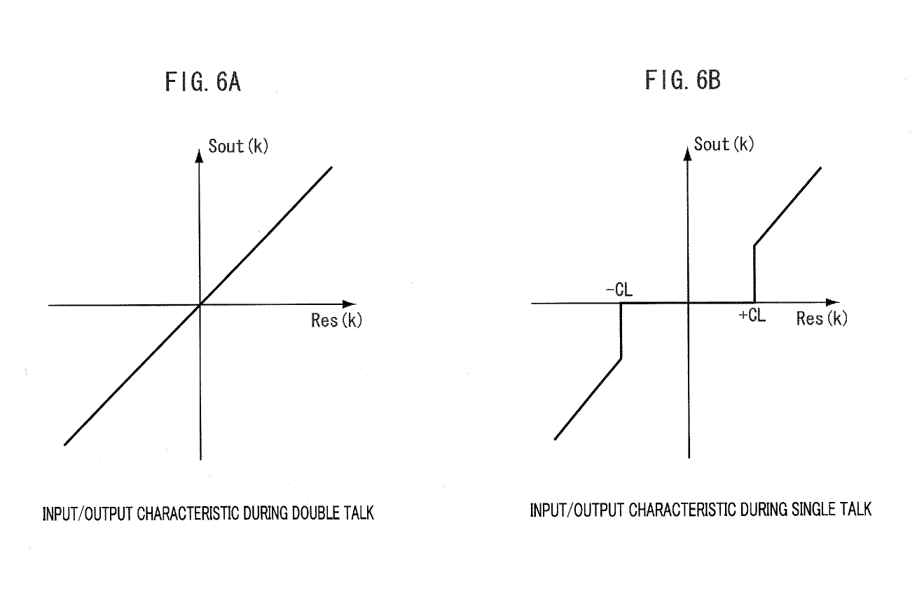

In the NLP 44, in a case where double talk has been detected by the DTD 42 (judged by the estimation inhibiting signal INH(k)), the NLP 44 shows a linear input/output characteristic such that speech on the near end does not become broken (see FIG. 6A). It will be noted that, in the case of a double talk state, speech is included in Rin(k) (the reflection coefficient C2(k) is exceeding the threshold value THc2), but it is alright if the NLP 44 does not perform speech detection.

On the other hand, in a case where single talk has been detected by the DTD 42, when the reflection coefficient C2(k) does not exceed the threshold value THc2, that is, when the NLP 44 has judged that speech is not included in Rin(k), the NLP 44 shows a nonlinear input/output characteristic such as shown in FIG. 2C, performs center clipping that forcibly outputs zero (digital transmission signal Sout(k)=0) if the absolute value of the residual signal Res(k) is equal to or less than a clip level CL1 (in the range of −CL1 to CL1), and suppresses residual echo.

Further, when the reflection coefficient C2(k) exceeds the threshold value THc2, that is, when the NLP 44 has judged that speech is included in Rin(k), that is, when the DTD 42 ends up detecting a single talk state because in a normal situation it is a double talk state but the ratio of echo to near end speech is large, in the present embodiment, instead of the input/output characteristic shown in FIG. 2C, the NLP 44 attenuates the residual signal Res(k) by an input/output characteristic such as shown in FIG. 2A or FIG. 2B, and outputs the attenuated residual signal.

In this manner, in a normal situation, it is a double talk state, but when the input/output characteristic of the NLP 44 ends up simply being changed from a single talk state to a double talk state, the input/output characteristic ends up being changed to the double talk state in the same manner as when speech is inputted from just the far end side, and a problem arises, which is not preferred. Thus, in the present embodiment, this problem is prevented by changing the input/output characteristic to an input/output characteristic such as shown in FIG. 2A or FIG. 2B.

The input/output characteristic shown in FIG. 2A is clipped, but is not completely clipped, when the absolute value of the residual signal Res(k) is equal to or less than the clip level CL1. The input/output characteristic is greatly attenuated when the absolute value of the residual signal Res(k) is the clip level CL1 and is gradually attenuated when the absolute value of the residual signal Res(k) is between the clip level −CL1 and the clip level +CL1. It will be noted that the extent to which the input/output characteristic is clipped is determined by the specification of the NLP 44 and the desired characteristic. The input/output characteristic is not completely clipped, so breaks in the digital transmission signal Sout(k) (analog transmission signal Sout) are improved in comparison to when the NLP 44 ends up operating by an input/output characteristic during normal single talk (FIG. 2C).

The input/output characteristic shown in FIG. 2B is clipped at or below a clip level CL2 whose absolute value is smaller than the absolute value of the clip level CL1, that is, the input/output characteristic is not clipped even when a residual signal Res(k) that is smaller than in FIG. 2C is inputted. It will be noted that the value of the clip level CL2 is determined by the specification of the NLP 44 and the desired characteristic. The absolute value of the clip level becomes smaller, so breaks in the digital transmission signal Sout(k) (analog transmission signal Sout) are improved in comparison to when the NLP 44 ends up operating by an input/output characteristic during normal single talk (FIG. 2C).

It will be noted that, in the present embodiment, the input/output characteristic is changed by NLP 44 from FIG. 2C to FIG. 2A or FIG. 2B on the basis of the above-described detection result, but the embodiment is not limited to this, and a circuit may also be configured such that an input/output characteristic change unit that changes the input/output characteristic is separately disposed.

Further, in the present embodiment, the linear predictor 46 calculates the 2-dimensional reflection coefficient C2(k) as a spectral parameter and performs speech detection by determining whether or not the 2-dimensional reflection coefficient C2(k) exceeds the threshold value THc2 for an amount of time equal to or greater than a set amount of time as a condition that has been predetermined, but the embodiment is not limited to this; for example, a linear prediction coefficient or an LSP (Line Spectral Pairs) coefficient may also be used as the spectral parameter, and a speech detector other than the linear predictor may also be used. It suffices as long as the detector can detect whether or not speech is included in the digital input signal Rin(k). It will be noted that the level of the input signal is normalized when the linear predictor 46 calculates the 2-dimensional reflection coefficient C2(k), so the 2-dimensional reflection coefficient C2(k) becomes the same when it is the same speech signal even if the levels of the speech signals are different, and it is alright even if the threshold value THc2 is not changed in response to the level of the input signal or peripheral noise, so using the 2-dimensional reflection coefficient C2(k) as the spectral parameter as in the present embodiment is preferred.

Further, in the present embodiment, in NLP 44, a case has been described where breaks in the transmission signal are prevented by changing the input/output characteristic during single talk to FIG. 2A or FIG. 2B, but the embodiment is not limited to this; in regard to NLPs of all formats that have been disposed with the purpose of imparting loss to and attenuating residual echo that could not be sufficiently cancelled just with an echo canceller body, the embodiment is applicable by changing the input/output characteristic corresponding to those NLP formats.

As described above, according to the echo canceller 10 of the present embodiment, when single talk has been detected by the DTD 42 and the 2-dimensional reflection coefficient C2(k) that has been calculated by the linear predictor 46 exceeds the threshold value THc2 for an amount of time equal to or greater than a set amount of time, the NIP 44 attenuates the residual signal Res(k) by the input/output characteristic shown in FIG. 2A or FIG. 2B and outputs the attenuated residual signal as Sout(k), so in comparison to when the NLP 44 operates by a normal single talk input/output characteristic (FIG. 2C), the effect that breaks in the digital transmission signal Sout(k) (analog transmission signal Sout) improve is obtained. Consequently, breaks in a transmission signal can be prevented even when a far end talker continues talking.

### Second Embodiment

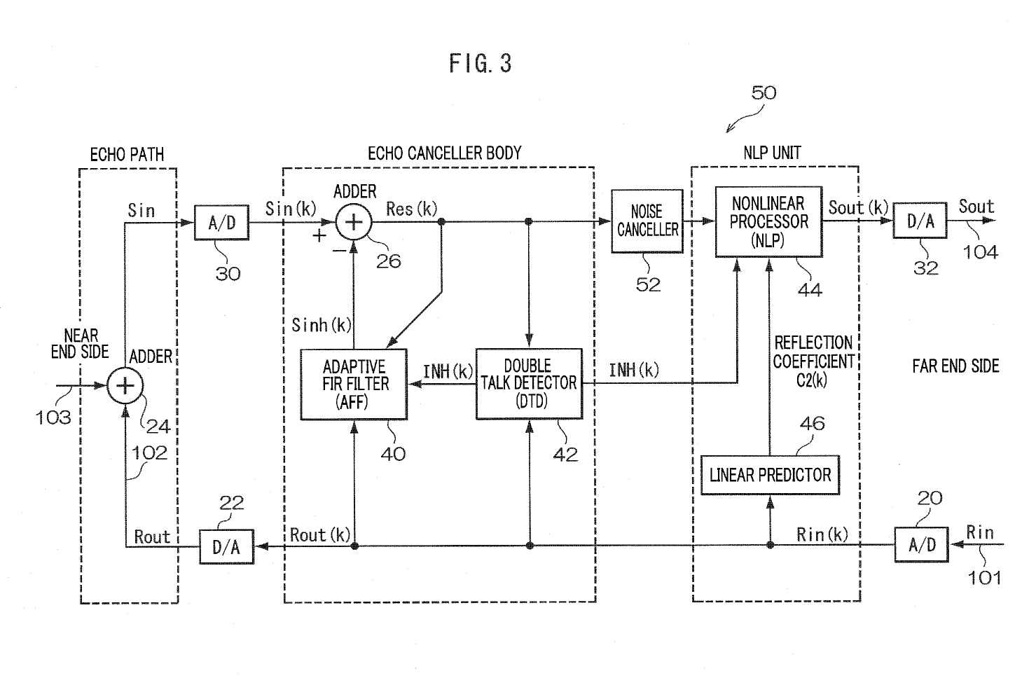

Next, a second embodiment of the present invention will be described in detail with reference to FIG. 3. FIG. 3 is a configural diagram showing an example of the general configuration of an echo canceller 50 pertaining to the second embodiment. It will be noted that, because the present embodiment has substantially the same configuration and operation as the first embodiment, the same reference numerals will be given to the same portions and detailed description will be omitted.

As shown in FIG. 3, the echo canceller 50 of the present embodiment is configured such that the echo canceller 10 of the first embodiment further includes a noise canceller 52.

Operation of the noise canceller 52 and the NLP 44 will be described in detail.

Usually, a noise canceller extracts and estimates a frequency component whose temporal change is gentle and steady as noise. Additionally, a noise canceller suppresses noise by subtracting, from speech with which noise is mixed that has been inputted from a microphone or the like, an amount corresponding to the size per frequency of the noise that has been estimated immediately before.

Consequently, when the far end talker continues talking (e.g., continues saying “ahh”), the noise canceller 52 of the present embodiment regards the echo thereof as peripheral noise and suppresses the noise. That is, the noise canceller 52 can suppress echo included in the residual signal Res(k).

For this reason, the residual signal Res(k) whose echo has been suppressed is inputted to the NLP 44. Consequently, the residual echo is reduced. In particular, residual echo that arises when the input/output characteristic is as in FIG. 2A or FIG. 2B is reduced.

As described above, according to the echo canceller 50 of the present embodiment, the echo canceller 50 is disposed with the noise canceller 52 that suppresses the noise of the residual signal Res(k), so the effect that residual echo can be reduced is obtained. Consequently, even when the far end talker continues talking and the 2-dimensional reflection coefficient C2(k) exceeds the threshold value THc2 for an amount of time equal to or greater than a set amount of time and the input/output characteristic of the NLP 44 during single talk is changed as in FIG. 2A or FIG. 2B, the echo thereof is suppressed by the noise canceller 52, so residual echo can be reduced in comparison to the first embodiment.

It will be noted that, in hands-free systems that are used in offices where air-conditioning noise exists or in vehicles where traveling noise is loud, there are many parts in which noise cancellers are originally installed, so when the present embodiment is applied with respect to those parts, there is the advantage that a significant increase in cost can be prevented.

### Third Embodiment

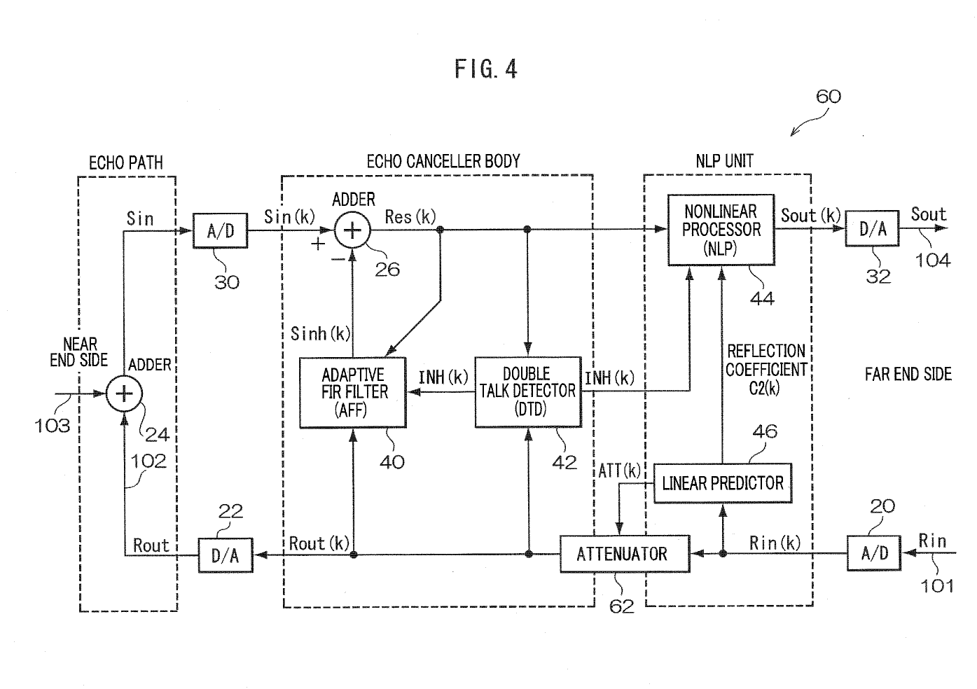

Next, a third embodiment of the present invention will be described in detail with reference to the FIG. 4. FIG. 4 is a configural diagram showing an example of the general configuration of an echo canceller 60 pertaining to the third embodiment. It will be noted that, because the present embodiment has substantially the same configuration and operation as the first embodiment, the same reference numerals will be given to the same portions and detailed description will be omitted.

As shown in FIG. 4, the echo canceller 60 of the present embodiment is configured such that the echo canceller 10 of the first embodiment further includes an attenuator 62.

Operation of the linear predictor 46 and the attenuator 62 of the present embodiment will be described in detail.

When the 2-dimensional reflection coefficient C2(k) exceeds the threshold value THc2 for an amount of time equal to or greater than a set amount of time, the linear predictor 46 outputs the reflection coefficient C2(k) with respect to the NLP 44 and outputs an attenuation control signal ATT(k) with respect to the attenuator 62. When the attenuation control signal ATT(k) is inputted to the attenuator 62, the attenuator 62 attenuates (e.g., attenuates by 6 dB) the digital reception signal Rin(k). That is, when speech is included in the digital reception signal Rin(k), the attenuator 62 attenuates the digital reception signal Rin(k). It will be noted that the attenuation amount of the attenuator 62 may be determined by the performance of the echo canceller body and the desired characteristic.

According to the echo canceller 60 of the present embodiment, the echo canceller 60 is disposed with the attenuator 62 that attenuates the digital reception signal Rin(k) when speech is included in the digital reception signal Rin(k), so the effects that, when the far end talker continues talking (e.g., continues saying “ahh”), the echo thereof can be attenuated, the ratio of echo to near end speech can be improved and residual echo can be reduced are obtained. Consequently, residual echo can be reduced in comparison to the first embodiment.

According to the present invention, when speech is included in the reception signal and the state of the transmission signal is a single talk state, the nonlinear processor attenuates the residual signal to a signal level based on a predetermined input/output characteristic that has been changed by the input/output characteristic change unit and outputs the attenuated residual signal, so even when the transmission signal is judged to be a single talk state as a result of the far end talker continuing to talk, breaks in the transmission signal can be prevented.

Further, speech is detected by the spectral parameter that has been calculated by the linear predictor, so detection of speech becomes easy.

Speech is detected when at least one of a 2-dimensional reflection coefficient, a linear prediction coefficient and an LSP coefficient satisfies a condition that has been predetermined, so detection of speech becomes even easier.

The residual signal is clipped, but is not completely clipped, to a predetermined value whose absolute value is at least greater than zero at a first clip level, so it becomes difficult for the transmission signal to become broken.

The residual signal is clipped at a second clip level whose absolute value is smaller than in the case of single talk, so it becomes difficult for the transmission signal to become broken.

Further, noise of the residual signal that is inputted to the nonlinear processor is suppressed by the noise canceller, so residual echo is reduced.

Moreover, the reception signal is attenuated, so the ratio of echo to near end speech improves.

What is claimed is:

1. An echo canceller comprising:
a residual signal generation unit that generates a pseudo echo signal, and generates a residual signal by subtracting the pseudo echo signal from a transmission signal that includes a residual echo generated by a reception signal;
a double talk detection unit that detects whether the state of the transmission signal is a double talk state or a single talk state;
a nonlinear processor that attenuates the residual signal that has been inputted thereto to a signal level which is based on an input/output characteristic that has been predetermined according to the state of the transmission signal, and that outputs the attenuated residual signal;
a speech detection unit that detects whether or not speech is included in the reception signal; and
an input/output characteristic change unit that changes the input/output characteristic of the nonlinear processor to a predetermined input/output characteristic when a single talk state has been detected at the double talk detection unit and speech has been detected at the speech detection unit.

2. The echo canceller according to claim 1, wherein the speech detection unit comprises a linear predictor that calculates a spectral parameter of the reception signal, and the speech detection unit detects speech when the spectral parameter satisfies a predetermined condition.

3. The echo canceller according to claim 2, wherein the spectral parameter is at least one of a 2-dimensional reflection coefficient, a linear prediction coefficient or an LSP coefficient.

4. The echo canceller according to claim 1, wherein
the nonlinear processor outputs zero when the absolute value of the level of the residual signal is equal to or less than a first clip level when the state of the transmission signal is a single talk state, and
the input/output characteristic change unit outputs a predetermined value whose absolute value is at least larger than zero when the absolute value of the level of the residual signal is the first clip level, and changes the input/output characteristic of the nonlinear processor to an input/output characteristic wherein the absolute value of the output value of the nonlinear processor gradually decreases when the output value lies within a range from a negative value of the first clip level to a positive value of the first clip level.

5. The echo canceller according to claim 1, wherein
the nonlinear processor outputs zero when the absolute value of the level of the residual signal is equal to or less than a first clip level when the transmission signal is a single talk state, and
the input/output characteristic change unit changes the input/output characteristic of the nonlinear processor to an input/output characteristic that outputs zero when the absolute value of the level of the residual signal is equal to or less than a second clip level whose absolute value is smaller than that of the first clip level.

6. The echo canceller according to claim 1, further comprising a noise canceller that suppresses noise included in the residual signal, wherein the nonlinear processor attenuates the residual signal whose noise has been suppressed by the noise canceller.

7. The echo canceller according to claim 1, further comprising an attenuator that imparts loss to and attenuates the reception signal.

8. The echo canceller according to claim 7, wherein the attenuator attenuates the reception signal when the speech detection unit has detected speech.
